(19) United States
(12) Patent Application Publication
(10) Pub. No.: US 2008/0178744 A1
(43) Pub. Date: Jul. 31, 2008

(54) TRANSPARENT BAG FOR USE IN PREPARING MICROWAVED POPCORN

(76) Inventor: Noel Marie Hill, Fontana, CA (US)

Correspondence Address: MARC E. HANKIN, ESQ., 11414 THURSTON CIRCLE, LOS ANGELES, CA, 90049, US

(21) Appl. No.: 11/669,884

(22) Filed: Jan. 31, 2007

(51) Int. Cl. A47J 36/00; B65B 29/08

(52) U.S. Cl. 99/323.5

(57) ABSTRACT

Various embodiments of the invention are directed towards a bag for heating and preparing popcorn in a microwave that allows users to view the popcorn as it is cooked. Various embodiments of the invention disclose a popcorn bag that features one or more transparent areas, allowing the user to view the popcorn as it is cooked.

### FIELD OF INVENTION

Various embodiments of this invention relate, generally, to containers used in preparing foods; more particularly, transparent bags for preparing popcorn in a microwave.

### BACKGROUND

Various means are known in the art for preparing popcorn by applying heat to unpopped popcorn kernels. In conventional popcorn heating, heat is applied through warm air, heating oil, or through convection heating means. In these preparing methods, popcorn kernels explode and the kernel puffs up when it is heated in oil or by dry heat. These methods are, however, sometimes undesirable because of the additional time required to prepare popcorn through conventional heating.

As a consequence of the popularity of microwave heating as a means for preparing foods, microwave ovens have also become a common means of heating and preparing popcorn. In the common systems known in the art, microwave popcorn is packaged in individual bags that are placed into the microwave oven. The microwave popcorn bag is useful because it contains the popcorn kernels as they explode and may further operate as a container for serving the popcorn. The popcorn bag may further be useful because it contains oils, butter, salt, and other flavorings that are commonly enjoyed with popcorn.

Microwave popcorn is highly popular because its preparation is quite simple. In the common manner, a bag of microwave popcorn is placed into a microwave and removed after a prescribed period of time and once the kernels have popped. Because the power emitted by microwaves and the time needed for kernels to pop widely vary, the time estimates for microwaving popcorn are generally unreliable. Often, following the package instructions without modification leads to undercooking, leaving many unpopped kernels, results from not leaving the bag in the microwave oven for long enough. On the other hand, if the popcorn bag is left in the microwave oven for too long, the popcorn can become burnt.

In order to determine whether or not all of the kernels have popped and the readiness of the microwave popcorn, a user must use various imprecise methods of guessing such as shaking the bag, observing how filled the bag is, or poking a small hole into the bag and looking inside. None of these methods, however, is reliable help in order to accurately and easily gauge whether or not the popcorn is prepared.

Various devices and methods have been developed in an effort to improve upon these conventional methods. One such device is disclosed by U.S. Pat. No. 3,835,280 to Gades, et al. Gades' patent discloses a device for concentrating the microwave energy emitted by a microwave oven to a single point or a small area. The device consists of a sheet of a low loss dielectric material together with a layer of microwave reflecting material. Gades' device is placed on the floor of the oven and on the opposite side of the product heated from the source of microwave energy in order to concentrate the microwave energy, for example, to a bag of microwave popcorn. The device does not, however, allow a person to view the popcorn as it is popping.

Another such device is disclosed by U.S. Pat. No. 4,888,459 to Keefer. Keefer's patent discloses a container for holding a body of material such as foodstuff to be heated in a microwave oven, the container including a dielectric lid and/or other dielectric wall structure with at least two contiguous dielectric wall portions that are configured to convert the microwave energy produced by the microwave oven into heat within the container. Keefer's device, however, fails to disclose a method whereby the user may monitor the foodstuffs as they are prepared.

Another such device is disclosed by U.S. Pat. No. 4,963,424 to Beckett. Beckett's device discloses laminate structures incorporating a thin metal layer of a thickness capable of converting incident microwave energy into thermal energy. In this manner, Beckett's device allows microwave energy to more expediently cook foods such as microwave popcorn.

Another such device is disclosed by U.S. Pat. No. 4,950,859 to Anderson. Anderson's device discloses a microwave cooking bag comprising two opposing side panels and an inwardly pleated bottom panel between the opposing side panels. The side panels are joined to one another along their side edges and to the bottom panel along its outside edge. Sections of the side panels may also be seamed or bonded to sections of the bottom panel so that the inside surface area of the bottom panel is substantially less than the outside surface area of the bottom panel. While Anderson's device is transparent to microwave energy, it is not transparent to light from the visible frequency range. Thus, users must gauge whether or not the popcorn is ready by the conventional methods discussed above.

Because of these shortcomings, there remains a long felt need in the art for a microwave bag for preparing popcorn wherein the user may visually observe the popcorn as it is being prepared in the microwave.

### DESCRIPTION OF THE INVENTION

In the following description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the description is to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, “bag” refers to any sealed container that is transparent to microwave radiation and used to store microwavable popcorn while it is heated; “window” refers to any portion of a bag that is transparent to visible light; and “plastic” refers to any polyethylene (PE), polypropylene (PP), polystyrene (PS), acrylonitrile butadiene styrene (ABS), polyethylene terephthalate (PET), polyvinyl chloride (PVC), polyurethanes (PU), polycarbonate (PC), polyvinylidene chloride (PVDC), or other such plastic material.

Various embodiments of the invention are directed towards overcoming the above shortcomings by disclosing a bag for heating and containing popcorn while it is prepared in a microwave that allows the user to view the popcorn as it is cooked.

In one embodiment of the invention, the bag has a generally cuboid shape, having a top, bottom, and four sides, with the length of the cuboid being greater than the depth of the cuboid, and the height of the cuboid expands as popcorn is prepared in the bag.

In various embodiments of the invention, the invention comprises a popcorn bag that is entirely constructed of a material that is transparent to visible light and microwave energy. Any of the various plastic materials discussed above that are transparent to visible light and microwave energy may be used in order to contain the popcorn and allow microwave energy to reach the popcorn kernels. As the kernels are popped, the viewer is able to view the popcorn and visually determine the ideal time for removing the bag and the popcorn from the microwave. In this manner, the invention improves on prior art systems that require the user to shake the bag or otherwise guess the preparedness of the popcorn, without actually viewing them.

In other embodiments of the invention, the popcorn bag comprises a bag that is predominantly made from a paper material that is transparent to microwave radiation. The popcorn bag features one or more plastic windows that are transparent to visible light and allow the user to view areas of the popcorn kernels as they are cooked. In various embodiments of the invention, the windows are further transparent to microwave radiation, such that microwave energy may pass through the windows and heat the popcorn kernels.

In various embodiments of the invention, the windows are located at the sides of the popcorn bag, such that, as the bag expands and is filled with popcorn, the windows become visible to the user. In an unexpanded state, the windows lie folded in the side of the popcorn bag. When the bag unfolds, the windows become fully visible and allow the user to view the kernels as they pop. In various embodiments of the invention, the popcorn bag further features written text on the bag in order to indicate which side of the bag should be placed facing the window of the microwave.

In various embodiments of the invention, the popcorn bag features a window at the top of the bag that is transparent to visible light and microwave radiation. When the bag is unexpanded and laying on its back, the bag is not visible from the perspective outside the microwave oven. The bottom of the bag, in these embodiments of the invention, features an expanding prop system that raises the far side of the bag, such that the window becomes visible as the popcorn kernels are popped.

In various embodiments of the invention, the expanding prop system comprises a section of folded paper that is filled with popcorn, as the kernels are expanded. The folded paper is located asymmetrically at the far side of the popcorn bag such that, as it is filled with popcorn kernels, the far side of the bag is propped upwards. These embodiments of the invention further allow the user to gauge the preparedness of the popcorn kernels by the height at which the bag is elevated. In various other embodiments of the invention, the expanding prop system comprises a partially filled air balloon or bladder that expands as the air within the balloon is filled. In this manner, because the balloon is located at the far side of the popcorn bag, as the bag inflates, the bag is propped towards the window of the microwave oven such that the user may view the popcorn as it is popped.

In summary, various embodiments of the invention disclose a popcorn bag that features one or more plastic windows, such that a user may view the popcorn and popcorn kernels as they are popped. The above description describes the principles of the invention in general terms. It should be noted that, in the interests of conciseness, details of the invention that are commonly known in the art are not specifically disclosed. Also, the principles of the invention may be practiced with any of the various appurtenances to microwave popcorn known in the art. Any reference or non-reference to a particular system, chemical, or solution should not be interpreted as a limit on the scope of the invention.

What is claimed is:

1. A popcorn bag configured for use in a microwave such that users may view the preparation of popcorn in the popcorn bag, comprising:
a bag, said bag having a generally cuboid shape having a top, bottom, and four sides, the length of said cuboid being greater than the depth of said cuboid, and the height of said cuboid expanding as popcorn is prepared in said bag, and
said bag comprising a material that is transparent to visible light and to microwave radiation such that microwave energy is transmitted to popcorn kernels as they are cooked in said bag and a user may view the preparation of the popcorn in said bag.

2. A popcorn bag configured for use in a microwave such that users may view preparation of popcorn in the popcorn bag according to claim 1, wherein said material is a plastic selected from the following plastics: polyethylene (PE), polypropylene (PP), polystyrene (PS), acrylonitrile butadiene styrene (ABS), polyethylene terephthalate (PET), polyvinyl chloride (PVC), polyurethanes (PU), polycarbonate (PC), or polyvinylidene chloride (PVDC).

3. A popcorn bag configured for use in a microwave such that users may view the preparation of popcorn in the popcorn bag, comprising:
a bag, said bag having a generally cuboid shape having a top, bottom, and four sides, the length of said cuboid being greater than the depth of said cuboid, and the height of said cuboid expanding as popcorn is prepared in said bag,
said bag generally comprising a first material that is configured to be transparent to microwave radiation and opaque to visible light, and
said bag including one or more plastic window sections, said one or more plastic window sections being configured of a second material that is transparent to microwave radiation and transparent to visible light.

4. A popcorn bag configured for use in a microwave such that users may view the preparation of popcorn in the popcorn bag according to claim 3, wherein said second material is a plastic selected from the following plastics: polyethylene (PE), polypropylene (PP), polystyrene (PS), acrylonitrile butadiene styrene (ABS), polyethylene terephthalate (PET), polyvinyl chloride (PVC), polyurethanes (PU), polycarbonate (PC), or polyvinylidene chloride (PVDC).

5. A popcorn bag configured for use in a microwave such that users may view the preparation of popcorn in the popcorn bag according to claim 3, wherein said one or more plastic window sections are located at the plane of said cuboid that defines the length and height of said cuboid.

6. A popcorn bag configured for use in a microwave such that users may view the preparation of popcorn in the popcorn bag according to claim 3, wherein said one or more plastic window sections are folded when said bag is in an unprepared stage and unfolded when said bag is in a prepared stage.

7. A popcorn bag configured for use in a microwave such that users may view the preparation of popcorn in the popcorn bag according to claim 3, wherein said one or more plastic window sections is located at the top of said bag and further featuring an expanding prop system located at the bottom of said bag.

8. A popcorn bag configured for use in a microwave such that users may view the preparation of popcorn in the popcorn bag according to claim 7, wherein said expanding prop system comprises: a folding section located at the bottom of said bag along one of the lengthwise edges such that, as the popcorn is prepared, the folds of said bag are unfolded and said expanding prop system elevates the bottom of said bag at said expanding prop system such that a user may view said one or more plastic window sections at the top of said bag.

9. A popcorn bag configured for use in a microwave such that users may view the preparation of popcorn in the popcorn bag according to claim 7, wherein said expanding prop system comprises: a bladder located at the bottom of said bag along of the lengthwise edges such that, as the popcorn is heated, air in said bladder expands, and elevates the bottom of said bag at said expanding prop system such that a user may view said one or more plastic window sections at the top of said bag.

10. A popcorn bag configured for use in a microwave such that users may view the preparation of popcorn in the popcorn bag, comprising:
a bag, said bag having a generally cuboid shape having a top, bottom, and four sides, the length of said cuboid being greater than the depth of said cuboid, and the height of said cuboid expanding as popcorn is prepared in said bag,
said bag generally comprising a first material that is configured to be transparent to microwave radiation and opaque to visible light, and
said bag including one or more plastic window sections, said one or more plastic window sections being located at the plane of said cuboid that defines the length and height of said cuboid, and
said one or more plastic window sections being configured of a second material that is transparent to microwave radiation and transparent to visible light, said second material being a plastic selected from the following plastics: polyethylene (PE), polypropylene (PP), polystyrene (PS), acrylonitrile butadiene styrene (ABS), polyethylene terephthalate (PET), polyvinyl chloride (PVC), polyurethanes (PU), polycarbonate (PC), or polyvinylidene chloride (PVDC).

11. A popcorn bag configured for use in a microwave such that users may view the preparation of popcorn in the popcorn bag, comprising:
a bag, said bag having a generally cuboid shape having a top, bottom, and four sides, the length of said cuboid being greater than the depth of said cuboid, and the height of said cuboid expanding as popcorn is prepared in said bag,
said bag generally comprising a first material that is configured to be transparent to microwave radiation and opaque to visible light, and
said bag including one or more plastic window sections, said one or more plastic window sections being located at the top of said cuboid,
said one or more plastic window sections being configured of a second material that is transparent to microwave radiation and transparent to visible light, said second material being a plastic selected from the following plastics: polyethylene (PE), polypropylene (PP), polystyrene (PS), acrylonitrile butadiene styrene (ABS), polyethylene terephthalate (PET), polyvinyl chloride (PVC), polyurethanes (PU), polycarbonate (PC), or polyvinylidene chloride (PVDC),
said bag featuring an expanding prop system at its bottom, said expanding prop system comprising a folding section located at the bottom of said bag along one of the lengthwise edges such that, as the popcorn is prepared, the folds of said bag are unfolded and said expanding prop system elevates the bottom of said bag at said expanding prop system such that a user may view said one or more plastic window sections at the top of said bag.
